(19) United States
(12) Patent Application Publication
(10) Pub. No.: US 2010/0175109 A1
(43) Pub. Date: Jul. 8, 2010

(54) ROUTE OPTIMISATION FOR PROXY MOBILE IP

(76) Inventor: Wassim Haddad, Boulder, CO (US)

Correspondence Address: ERICSSON INC., 6300 LEGACY DRIVE, M/S EVR 1-C-11, PLANO, TX, 75024, US

(21) Appl. No.: 12/601,250

(22) PCT Filed: May 25, 2007
(86) PCT No.: PCT/EP2007/055134

§ 371 Date: Nov. 20, 2009

(51) Int. Cl. H04L 29/06

(52) U.S. Cl. 726/3

(57) ABSTRACT

A method of establishing a route optimisation mode between a mobile node and a correspondent node across a mobile IP network. The method comprises establishing a bi-directional security association between a proxy mobile agent to which the mobile node is attached or to which the mobile node will attach, and the correspondent node. On behalf of the mobile node, the proxy mobile agent performs a reachability test with the correspondent node via a home agent of the mobile node, and sends a binding update to the correspondent node.

### TECHNICAL FIELD

The invention relates to route optimisation for Proxy Mobile IP.

### BACKGROUND

Mobile IP (MIP), which is described in IETF RFC 3344, allows users of mobile communications devices to move from one network to another whilst maintaining a permanent IP address, regardless of which network they are in. This allows the user to maintain connections whilst on the move. For example, if a user were participating in a Voice Over IP (VoIP) session with a Correspondent Node (CN) and, during the session the user moved from one network to another, without MIP support the user's IP address may change. This would lead to problems with the VoIP session.

According to MIPv6, a Mobile Node (MN) is allocated two IP addresses: a permanent home address within a home network and a care-of address (CoA) within a visited network. The CoA is associated with a node (Access Router, AR) in the network that the user is currently visiting. The AR periodically broadcasts a routing prefix which is associated with the visited network. A MN wishing to attach to the visited network receives the routing prefix and uses this to generate an IPv6 CoA. To communicate with the MN, packets are sent to the MN's home address. These packets are intercepted by a Home Agent (HA) in the home network, which has knowledge of the current CoA. The HA then tunnels the packets to the CoA of the MN with a new IP header, whilst preserving the original IP header. This mechanism is illustrated in FIG. 1, where the term “HA” designates the contact address of the Home Agent and “CN” designates the address of the Correspondent Node. When the packets are received by the MN, it removes the new (outer) IP header and obtains the original (inner) IP header. The MN sends packets directly to a CN node via the visited network.

Route Optimisation (RO) is a procedure used in mobility networks to improve the efficiency with which messages are sent between a MN and a Correspondent Node (CN). More particularly, traffic sent from the CN to the MN is routed directly to the MN and does not pass through the HA. Mobility Support in IPv6 (IETF RFC 3775 June 2004) describes RO initiated by the MN for messages sent to the MN from a CN.

Signalling associated with setting up RO in a MIPv6 network is illustrated in FIG. 2. The procedure is initiated by the MN sending a Binding Update (BU) to its HA to update the HA of its current location. The HA returns a Binding Acknowledgement (BA). There then follows a six message exchange. The first four messages relate to a “return routability” procedure which is performed to verify to the CN that the MN is reachable at both the claimed HoA and the claimed CoA. The MN sends a Home Test Init (HoTI) message to the CN via the HA. [The HA can at this stage make a decision, based upon installed policies, on whether or not RO is allowed for the MN. If not the HA may block the HoTI message.] The CN returns a Home Test (HoT) message to the HoA address, the message containing a first part of a key generated by the CN. The message is relayed to the MN by the HA. The MN then sends a Care of Test Init (CoTI) message directly to the CN. The CN returns a Care of Test (CoT) message containing a second part of the key, the message being addressed to the CoA. Assuming that the MN receives both the HoT and the CoT messages, it is able to recover the key. The MN then sends a BU directly to the CN and which contains a signature generated using the now shared key. The CN returns to the MN a Binding Acknowledgement (BA). At this stage, both the CN and the MN have entered the binding between the HoA and the CoA into their binding tables. Thereafter, the CN can send packets directly to the MN at the CoA.

The AR in MIPv6 plays no active part in mobility, other than to provide a visited network prefix (from which the MN generates its CoA). However, it has been recognised that a more efficient approach to mobility is to delegate responsibility for mobility signalling to the AR. To this end, Proxy Mobile IPv6 (PMIPv6), IETF draft-ietf-netlmm-proxymip6-00, describes a Proxy Mobile Agent (PMA) function. This function emulates home link properties in order to make a MN behave as though it is on its home network and allows support for mobility on networks that would not otherwise support MIPv6. PMIPv6 avoids the need for packet “tunneling” on the first hop (i.e. between the HA and the PMA).

A PMA is usually implemented at the AR. The PMA sends and receives mobility related signalling on behalf of a MN. When a MN connects to an AR having a PMA, the MN presents its identity in the form of a Network Access Identifier (NAI) as part of an access authentication procedure. Once the MN has been authenticated (typically contacting the MN's home network using the AAA procedures), the PMA configures the user's profile from a policy store. The PMA, having knowledge of the user's profile and the NAI, can now emulate the MN's home network. The MN subsequently obtains its home address from the PMA. The PMA also informs the MN's Home Agent of the current location (i.e. CoA) of the MN and the PMA using a Proxy BU (PBU) message. Upon receipt of the PBU, the Home Agent sets up a tunnel to the PMA and sends a Proxy BA (PBA) to the PMA. On receipt of the PBA, the PMA sets up a tunnel to the HA. All traffic from the MN is routed to the HA through this tunnel. The HA receives any packet that is sent to the MN from a CN, and forwards the received packet to the PMA through the tunnel. On receipt of the packet, the PMA removes the tunnel header and sends the packet to the MN. The PMA acts as a default router on the access link.

Unlike MIPv6, the current Proxy MIPv6 specification doesn't assume any mobility management protocol in the MN. The techniques for route optimization specified in MIPv6 cannot be applied to PMIPv6 without modification. Nonetheless, PMA is well placed to process route optimization signalling on behalf of the MN. One possibility is of course to apply the “classic” RO solution between the PMA and the CN, without involving the MN. In this case, the PMA will conduct the return routability exchange with the CN, and send the BU to the CN. Signalling associated with this approach is illustrated in FIG. 3. However, it is recognised that applying the classic RO approach to PMIPv6 has a number of drawbacks including the high signalling load placed on the PMA and the CN, and the high number of bidirectional Security Associations (BSAs) which must be maintained by the PMA and the CN.

In the case of MIPv6, a protocol referred to as OMIPv6 has been proposed (IETF RFC4866). OMIPv6 reduces the mobility related signalling by requiring only one HoTI/HoT exchange (during the first IP handoff) and no signaling exchange at all in case that the MN is not moving (while MIPv6 requires a full return routability exchange every 7 minutes even if the MN is not moving). However, OMIPv6 still require a CoTI/CoT exchange at each IP handoff. FIG. 4 illustrates the signaling associated with OMIPv6 following attachment of a MN to a new AR and establishment of a session with a new CN. FIG. 5 illustrates the reduced signalling required when the MN moves to a new AR and continues the session with the same CN (i.e. the need for the HoTI/HoT exchange is avoided).

### SUMMARY

The present invention stems from a recognition that a number of MNs attached to a single PMA may be communicating with the same CN. Indeed, the number of such MNs may be very large. Consider for example a group of travelling fans attending a large sporting event and who share a home network. Many of these fans may want to download information from the same server (CN). It is possible to generate a single BSA for the PMA and the CN which can be shared by all MNs. The BSA is bound to a specific routing prefix owned by the PMA, rather than by any one MN.

According to a first aspect of the present invention there is provided a method of establishing a route optimisation mode between a mobile node and a correspondent node across a mobile IP network. The method comprises establishing a bi-directional security association between a proxy mobile agent to which the mobile node is attached or to which the mobile node will attach, and the correspondent node. On behalf of the mobile node, the proxy mobile agent performs a reachability test between itself and the correspondent node via a home agent of the mobile node, and sends a binding update to the correspondent node and which is authenticated using said security association.

Embodiments of the present invention avoid the need for a separate care-of-address reachability test for each mobile node attaching to the same correspondent node, or each time a care-of-address reachability test is repeated for a given mobile node. By way of example, the CoTI/CoT exchange need not be repeated. The advantage is reduced signalling volumes, reduced setup times, and a reduction in the number of security associations that must be stored at network nodes.

Typically, said bi-directional security association is bound to a network address prefix owned by the proxy mobile agent and which is usable by mobile nodes attaching to the proxy mobile agent to generate a care-of-address. As such, said bi-directional security association can be relied upon by a plurality of mobile nodes attached to said proxy mobile agent, with said reachability test being performed separately for each mobile node.

The care-of-address reachability test, that is the establishment of the bi-directional security association, may be carried out in direct response to a mobile node attaching to the proxy mobile agent, or starting a session with a correspondent node following attachment, or may be initiated independently by the network.

According to second aspect of the present invention there is provided a proxy mobile agent for use within a mobile IP network and configured to establish a bi-directional security association with a correspondent node, and, on behalf of a mobile node, to perform a reachability test with the correspondent node via a home agent of the mobile node, and send a binding update to the correspondent node.

According to third aspect of the present invention there is provided a home agent for use within a mobile IP network and configured to initiate a HoTI/HoT exchange with a correspondent node upon receipt of a proxy binding update from a proxy mobile agent to which a mobile node is attached, the home agent being configured to forward the HoT to the proxy mobile agent.

### BRIEF DESCRIPTION OF THE DRAWINGS

FIG. 1 illustrates schematically packet routing within a MIPv6 network where route optimisation is not applied;

FIG. 2 illustrates signalling within a MIPv6 network required to establish route optimisation;

FIG. 3 illustrates signalling within a PMIPv6 network required to establish route optimisation and employing classic MIPv6 route optimisation;

FIG. 4 illustrates signalling associated with an optimised MIPv6 protocol when a MN establishes a session with a new CN;

FIG. 5 illustrates signalling associated with an optimised MIPv6 protocol when a MN attaches to a new AR and has an already established session with a CN

FIG. 6 illustrates signalling associated a proposed enhanced route optimisation procedure for MIPv6 where a PMA has no pre-established bi-directional security association with a CN;

FIG. 7 illustrates signalling associated a proposed enhanced route optimisation procedure for MIPv6 where a PMA has a pre-established bi-directional security association with a CN; and

FIG. 8 illustrates signalling associated with establishment of a bi-directional security association between a PMA and a CN which is not triggered by a MN.

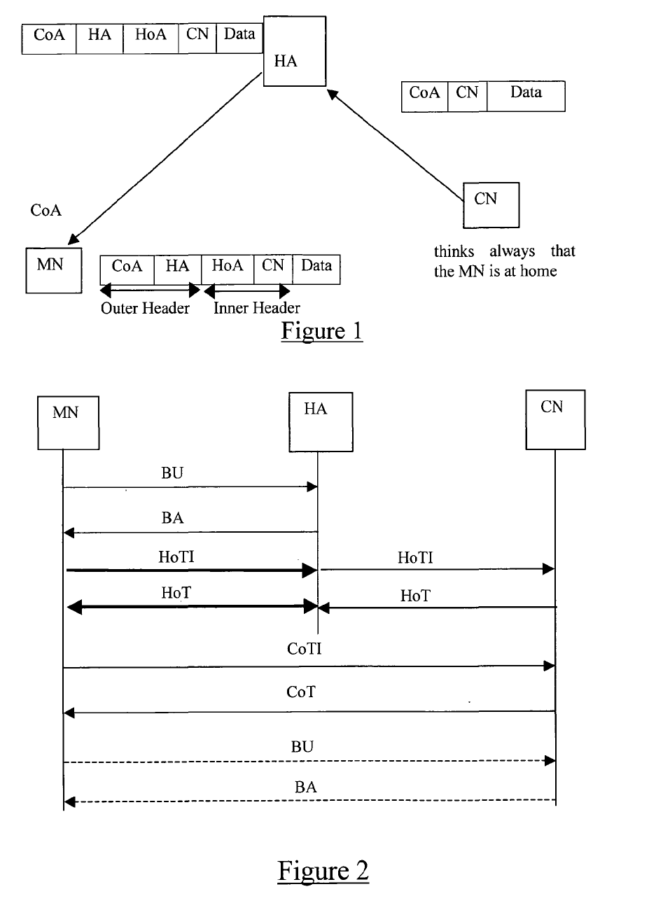

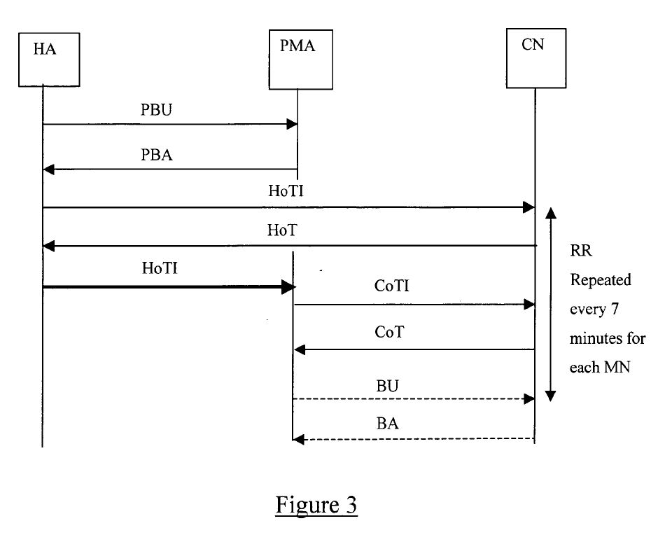

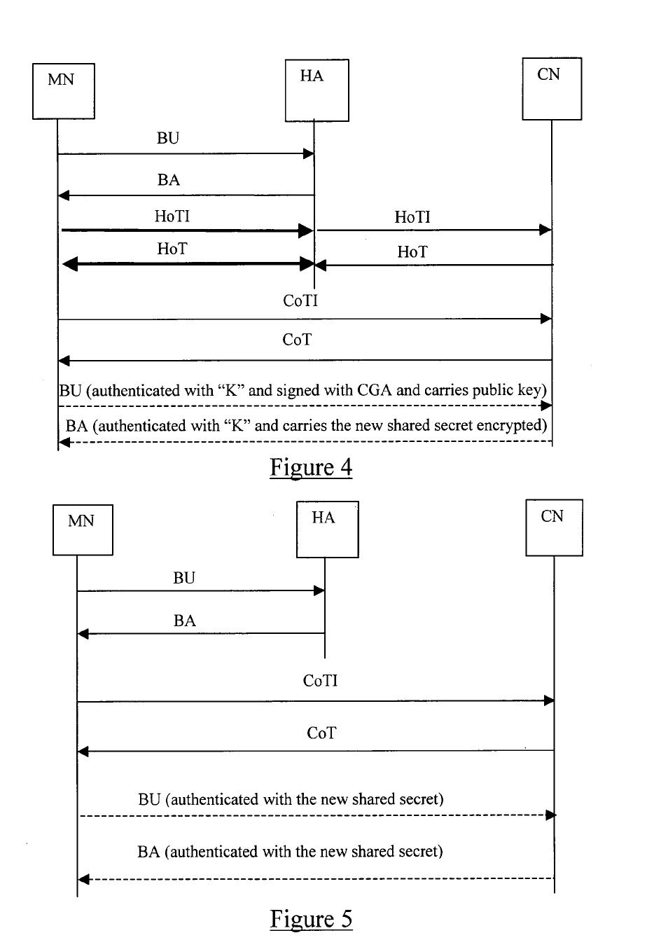

### DETAILED DESCRIPTION

Consider a Mobile Node (MN) having a subscription to a Home Network, and which roams into a visited network. According to a modified PMIPv6 procedure considered here, the Access Router (AR) incorporating a Proxy MIP Agent (PMA) will periodically broadcast to all MNs within its coverage area a Router Advertisement (RA) message. The RA contains a local routing prefix P_{M} owned by the AR. This means that the AR is advertising only its own prefix P_{M} on the link. Assuming that the MN is MIPv6 aware, the MN configures a care-of address (CoA) using P_{M} and waits until data packets are routed to its new CoA.

The first thing that the PMA must do is to send a binding update to the HA on behalf of the MN in order to inform the HA of the MNs new location, i.e. its CoA. The PMA sends the binding update in the form of a Proxy Binding Update (PBU). The HA returns a Proxy Binding Acknowledgement (PBA) to the PMA. When the MN enters into a session with a Correspondent Node (CN), RO will initially not be applied and IP packets will flow through the HA. The HA becomes aware of the CN address and will then take a decision on whether or not RO can be employed between the MN and the CN (typically based upon installed policies). Assuming that RO can be employed, the HA sends a HoTI message to the CN containing the MNs HoA as source address. The HoTI message is sent unprotected to the CN. After receiving the HoTI message, the CN generates a home keygen token and sends it to the MN's HoA within a HoT message. The HA intercepts the HoT message and forwards it to the PMA, typically within the PBA.

At this stage, the PMA determines whether or not it has an established long lifetime bidirectional Security Association (BSA) with the CN. Assuming that it does not, the PMA must establish such a BSA, and then bind the BSA to the prefix P_{M} being advertised by the PMA on the local link The procedure is as follows:
The PMA triggers a CoA reachability test and uses its ingress interface address as source address in the CoTI message sent to the CN.
The CN sends back a CoT message, which carries a care-of-keygen token.
After getting the CoT message, the PMA sends a PBU message to the CN and sets a new bit called “Bypass” (B) to indicate to the CN the absence of a HoA and to request a “prefix binding entry” (PBE) between the prefix P_{M} and a shared secret (Ks) to be generated by the CN. The PBU is authenticated using the care-of-keygen token. The PBU contains a public key of the PMA.
Assuming that the CN is able to validate the PBU using the care-of-keygen token, the CN creates a PBE in its binding cache table and establishes a BSA with the PMA.
The CN sends a Proxy BA (PBA) to the PMA and sets a “B” bit in the message. The PBA message carries Ks, which is encrypted with the PMA's public key.

At this stage, a BSA has been established between the PMA and the CN. The PMA then conducts a further PBU/PBA exchange with the CN on behalf of the MN. More specifically, it extracts the home keygen token from the HoT message received earlier from the CN via the HA, inserts it in a PBU message, and sends the PBU to the CN. The PBU contains the new CoA of the MN. In addition, the PMA must set a new bit called “Inner-Binding” (IB) and must authenticate the PBU by signing it with Ks (some parts of the PBU may also be encrypted). The PBU message must carry also the MN's HoA.

Upon receiving a PBU with the “IB” bit set, the CN checks if the MN's CoA prefix (i.e., P_{M}) is already stored in its PBE table. If the P_{M} is found, the CN proceeds to check the home keygen token to confirm that the PMA received the HoT from the HA and therefore that the PMA is trusted by the HA. The CN then validates the authenticity of the PBU message with the Ks (associated with the appropriate entry in the binding table). The CN then creates an inner-binding (IB) between the MN's HoA and CoA and includes it to the corresponding PBE. The CN can then start routing data packets to the MN's CoA.

Finally, a PBA message is sent from the CN to the PMA. The PBA message is sent to the PMA address stored in the corresponding PBE, and is authenticated by the PMA using Ks. The CN again sets the “IB” bit in the PBA message.

Each time the PMA has to refresh the MN's “existing” Inner Binding (IB), typically every few minutes, it sends a new PBU message to the CN. For this purpose, the PMA includes the “IB” bit in the PBU. The CN does not need to request a fresh home keygen token in the new PBU.

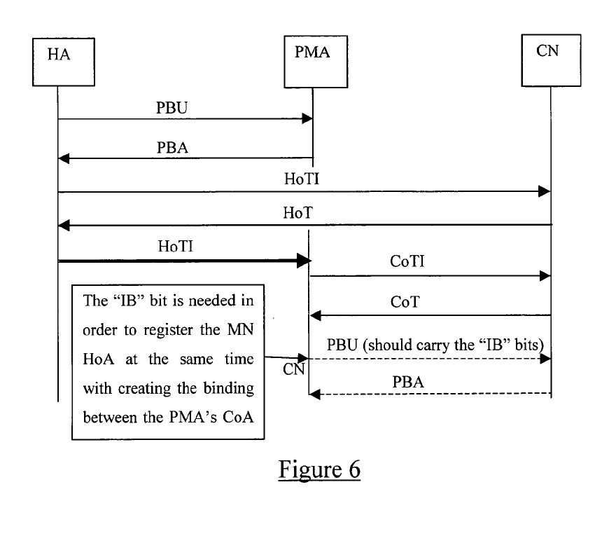

The complete signalling flow is illustrated in FIG. 6.

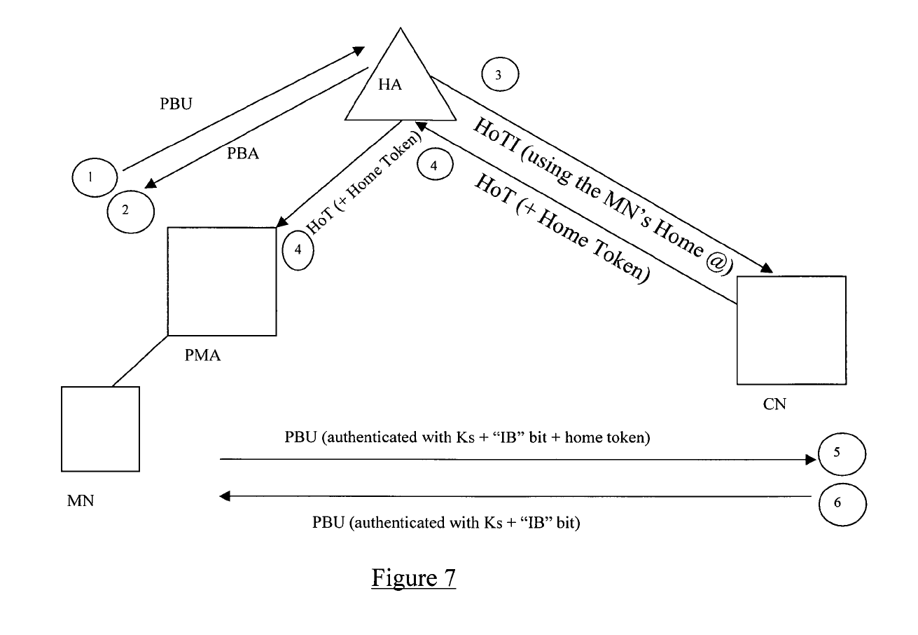

Consider now the case where a further MN attaches to the same PMA and establishes a session with the same CN. As a BSA already exists between the PMA and CN, there is no need to repeat the CoTI/CoT exchange. This fact will be detected when the PMA receives the HoT from the MN's HA. Upon receipt of the HoT, the PMA will immediately conduct the PBU/PBA exchange with the CN on behalf of the MN. This simplified procedure is illustrated in FIG. 7. The connection set-up time is significantly reduced as is the signalling load on the CN. In addition, the number of BSAs that must be maintained by the PMA (and the CN) is reduced (to one).

When a MN relocates to a new PMIPv6 domain, any ongoing connections must be “handed over” to the new PMA in order to reroute data packets to the new CoA, i.e. a RO mode must be initiated with the or each CN. In the event that the new PMA has not already established a BSA with a CN, the procedure illustrated in FIG. 6 is carried out. Alternatively, if a BSA already exists, the procedure of FIG. 7 is carried out.

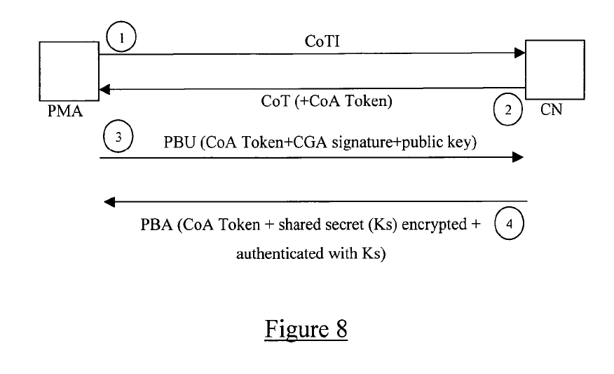

It is possible that a PMA may decide to establish a BSA with a given CN without first receiving a request on behalf of a MN. This might occur, for example, when a network determines that a large volume of “hits” will be made on a given CN. In this case, the PMA initiates the CoTI/CoT exchange illustrated in FIG. 8 in order to establish a long lifetime BSA with the CN.

The MN's HA should also create a binding at the CN side between each prefix advertised and a long lifetime shared secret. The goal of such binding is to enable the HA to release the corresponding IB if and when the MN switches from a PMIPv6 domain back to the home domain without making any stop(s). In this scenario, the HA must send a PBU message to the CN to indicate the MN presence at home and to request removing any IB. A mechanism to achieve this is to have the PMA send a key to the HA which is derived from the long lifetime secret which is shared between the PMA and the CN. By way of example, the key (a “release key” (Kr)) may be derived as: Kr=SHA1[(SHA1(K)|HoA)]. The key may be sent by the PMA to the HA as a new option in the PBU message. The advantage of this approach is that it does not require the CN to pre-compute and store Kr (in its binding cache) as it can easily compute it when receiving a PBU from the HA and which carries the MN's HoA.

It will be appreciated by the person of skill in the art that various modifications may be made to the above described embodiments without departing from the scope of the present invention. In particular, whilst the invention has been illustrated above in the context of MIPv6 enabled nodes, the invention can be applied to mobile nodes which are not so enabled. In this case, the PMA may send a unicast Router Advertisement (RtAdv) message to each mobile node to allow each node to maintain a “home” address. The PMA includes the home address of the MN in the PBU that it sends to the CN, and the CN creates an IB between the home address and the CoA (an egress interface address of the PMA as opposed to an ingress address as discussed above).

1. A method of establishing a route optimisation mode between a mobile node and a correspondent node across a mobile IP network, the method comprising:
establishing a bi-directional security association between a proxy mobile agent to which the mobile node is attached or to which the mobile node will attach, and the correspondent node; and
on behalf of the mobile node, performing a reachability test between the proxy mobile agent and the correspondent node via a home agent of the mobile node, and sending a binding update from the proxy mobile agent to the correspondent node, which is authenticated using said security association.

2. The method according to claim 1, wherein said bi-directional security association is bound to a network address prefix owned by the proxy mobile agent and is usable by mobile nodes attaching to the proxy mobile agent to generate a care-of-address.

3. The method according to claim 1, wherein said bi-directional security association is relied upon by a plurality of mobile nodes attached to said proxy mobile agent, said reachability test being performed separately for each mobile node.

4. The method according to claim 1, wherein said step of establishing a bi-directional security association comprises receiving at the proxy mobile agent a security key generated at and sent by the correspondent node.

5. The method according to claim 1, wherein said step of establishing a bi-directional security association comprises exchanging CoTI and COT messages, according to MIPv6, between the proxy mobile agent and the correspondent node.

6. The method according to claim 1, wherein said step of performing a reachability test comprises
exchanging binding update and binding acknowledgement messages between the proxy mobile agent and the home agent, and HoTI and HoT messages, according to MIPv6, between the home agent and the correspondent node, the HoT message being forwarded to the proxy mobile agent by the home agent.

7. The method according to claim 6 comprising receiving said HoT message at the proxy mobile agent and including in the binding update sent to the correspondent node a home keygen token, generated by the correspondent node, and extracted from said HoT message, and signing the binding update to be sent to the correspondent node with said security key.

8. The method according to claim 1, wherein said proxy mobile agent is located within a visited network from the viewpoint of the mobile node, and the mobile node is allocated a care-of-address address by the proxy mobile agent, said binding update creating, at the correspondent node, an inner binding between the home address and a care-of-address.

9. The method according to claim 1, wherein said step of establishing a bi-directional security association between the proxy mobile agent and the correspondent node is carried out in response to the mobile node attaching to the proxy mobile agent.

10. The method according to claim 9, wherein said step of establishing a bi-directional security association is carried out following a proxy binding update/proxy binding acknowledgement exchange between the proxy mobile agent and the home agent on behalf of the mobile node.

11. The method according to claim 1, wherein said step of establishing a bi-directional security association is carried out without initiation from a mobile node.

12. A proxy mobile agent for use within a mobile IP network and configured to establish a bi-directional security association with a correspondent node, and, on behalf of a mobile node, to perform a reachability test with the correspondent node via a home agent of the mobile node, and send a binding update to the correspondent node.

13. The proxy mobile agent according to claim 12 and arranged to establish a bi-directional security association using a CoTI/CoT exchange with a correspondent node.

14. The proxy mobile agent according to claim 12 and arranged to conduct a reachability test using a HoTI/HoT exchange.

15. The proxy mobile agent according to claim 12 and configured to establish a bi-directional security association with a correspondent node which is bound to a network address prefix owned by the proxy mobile agent and which is usable by mobile nodes attaching to the proxy mobile agent to generate a care-of-address.

16. The proxy mobile agent according to claim 12 and configured to utilize utilise said bi-directional security association for a plurality of mobile nodes attached to the proxy mobile agent, said reachability test being performed separately for each mobile node.

17. The proxy mobile agent according to claim 12 and configured to receive a security key generated at and sent by the correspondent node as part of configuring said bi-directional security association.

18. A home agent for use within a mobile IP network and configured to initiate a HoTI/HoT exchange with a correspondent node upon receipt of a proxy binding update from a proxy mobile agent to which a mobile node is attached, the home agent being configured to forward the HoT to the proxy mobile agent and including in the binding update a home keygen token, generated by the Correspondent Node, extracted from the HoT, and signing the binding update to be sent to the correspondent node with a security key.
